(19) United States
(12) Patent Application Publication
(10) Pub. No.: US 2002/0174236 A1
(43) Pub. Date: Nov. 21, 2002

(54) Methods and apparatus for processing data in a content network

(76) Inventors: Sanjay Mathur, Chicago, IL (US); Baiju Shah, Palatine, IL (US); Jc Groon, Chicago, IL (US)

Correspondence Address: VEDDER PRICE/ACCENTURE, 222 NORTH LASALLE STREET, CHICAGO, IL, 60601, US

(21) Appl. No.: 09/817,917

(22) Filed: Mar. 26, 2001

(51) Int. Cl. G06F 15/16; G06F 12/14; H04L 9/32

(52) U.S. Cl. 709/229; 713/200

(57) ABSTRACT

Adding contextual information to a plurality of discrete components facilitates the creation of enhanced data. Prior to the addition of the contextual information, each discrete component may be translated into a common representation format when necessary. The transformed discrete components resulting from the addition of contextual information are then aggregated according to at least one aggregation rule to provide the enhanced content. The enhanced content may be provided to or received from parties external to the given content network under the control of a digital identity associated with the given content network. Feedback regarding enhanced content provided to third parties may be used to further modify the contextual information corresponding to the enhanced content.

### FIELD OF THE INVENTION

The present invention relates to logical networks, referred to as content networks, comprising data across one or more physical networks and, in particular, to a method and apparatus for processing data in content networks.

### BACKGROUND OF THE INVENTION

It is commonplace today for an entity, such as an individual or institution (e.g., a corporation) to store a variety of data in a variety of different physical networks. In this context, a “network” may be broadly interpreted to include not only systems in which remote storage devices are coupled together via a set of communication paths, but also stand-alone devices that may be coupled, from time to time, to such systems and that have storage capability. Examples of this are illustrated in FIGS. 1 and 2. Referring to FIG. 1, an individual may have different data stored in their portable network 102 (e.g., a personal digital assistant), a home network 104 (e.g., a desktop computer), a work network 106 (e.g., a laptop computer) and an automobile network 108 (e.g., an on-board computer). Of course, other physical networks may be readily incorporated or substituted in the example of FIG. 1. Each of these networks 102-108 may be coupled to a communication network 110 such that the data contained in the networks 102-108 is commonly available to the individual. A similar example is illustrated in FIG. 2 regarding a corporate entity in which a human resources network 202, an Information Technologies (IT) network 204, a warehouse network 206 and a call center network 208 are similarly coupled to a communication network 210. To the extent that the data shown in FIGS. 1 and 2 may be attributed to a single entity, the data may be collectively referred to as a content network. That is, a content network, as opposed to a physical network, is comprised of the data residing across all of an entity's networks.

While content networks currently provide value to the entities to which they uniquely correspond, the data included in such content networks also includes value not currently available to third parties. In particular, data that is not proprietary to an entity and that would be useful to third parties represents the most likely opportunity to realize this value. For example, an individual may be willing to share his or her music preferences as represented by the music files stored on his or her home computer and radio station settings in a car. This data would likely be very useful, for example, to an advertising agency or music distribution enterprise. However, such data is currently not available to third parties absent a significant effort to manually gather it. It would therefore be advantageous to provide a technique whereby value contained in entities' content networks, but not otherwise available to third parties, may be efficiently gathered and provided by consenting entities to interested parties.

### SUMMARY OF THE INVENTION

The present invention provides a technique whereby value embodied by data in content networks may be more readily realized. In particular, adding contextual information to a plurality of discrete components facilitates the creation of enhanced data. Each discrete component is any piece of data or information from a given content network that can be digitally represented and stored. Prior to the addition of the contextual information, each discrete component is preferably translated into a common representation format when necessary. The transformed discrete components resulting from the addition of contextual information are then aggregated according to at least one aggregation rule to provide the enhanced content. The enhanced content may be provided to or received from parties external to the given content network under the control of a digital identity associated with the given content network. Feedback regarding enhanced content provided to third parties may be used to further modify the contextual information corresponding to the enhanced content.

In one embodiment of the present invention, the contextual information is any value-added information that can be added to a discrete component and may comprise, for example, information regarding the source, intended destination or characteristics of the data component or components. Further still, the contextual information preferably comprises access rights or usage rules respectively instructing the digital identity who may gain access to the enhanced content and how they may use the enhanced data. These and other advantages and embodiments will be apparent from the detailed description that follows.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary content network corresponding to an individual in accordance with the prior art;

FIG. 2 is a block diagram illustrating an exemplary content network and corresponding to a corporation in accordance with the prior art;

FIG. 3 is a schematic illustration of enhanced data in accordance with the present invention;

FIG. 4 is a schematic illustration of a digital identity in accordance with the present invention;

FIG. 4A is a flowchart illustrating the operation of a digital identity in accordance with the present invention;

FIG. 5 is a block diagram illustrating an exemplary content network corresponding to an individual in which a digital identity in accordance with one embodiment of the present invention is used to control provision of enhanced data to third parties;

FIG. 6 is a block diagram illustrating an exemplary content network corresponding to a corporation in which a digital identity in accordance with another embodiment of the present invention is used to control provision of enhanced data to third parties;

FIG. 7 is a schematic illustration of an application architecture that may be used to implement the present invention;

FIG. 8 is a block diagram of a physical architecture that may be used to implement the present invention;

FIG. 8A is a flowchart illustrating a method for transmitted enhanced content in accordance with the present invention;

FIG. 9 is a block diagram of a typical prior art workstation and communication connections that may be used to implement the present invention;

FIG. 10 is a flowchart illustrating a method for processing data in accordance with the present invention;

FIG. 11 is a screen that may be presented to user shopping for electronics and appliances in accordance with the present invention; and

FIG. 12 is a screen that may be presented to user while shopping and after retrieving enhanced content in accordance with the present invention.

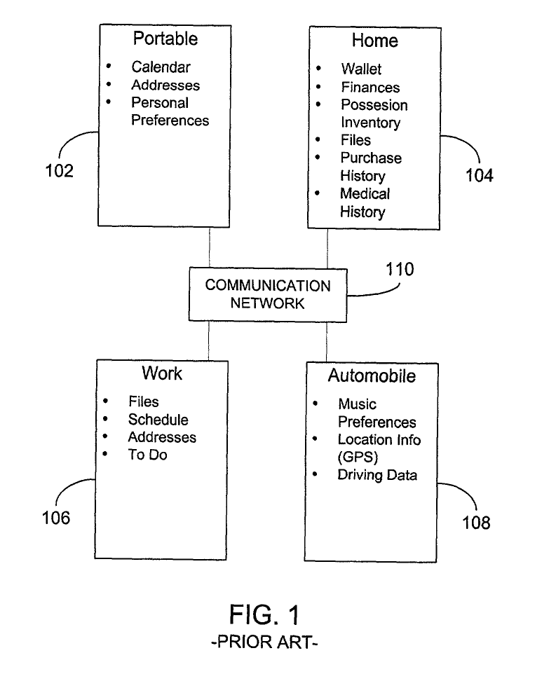

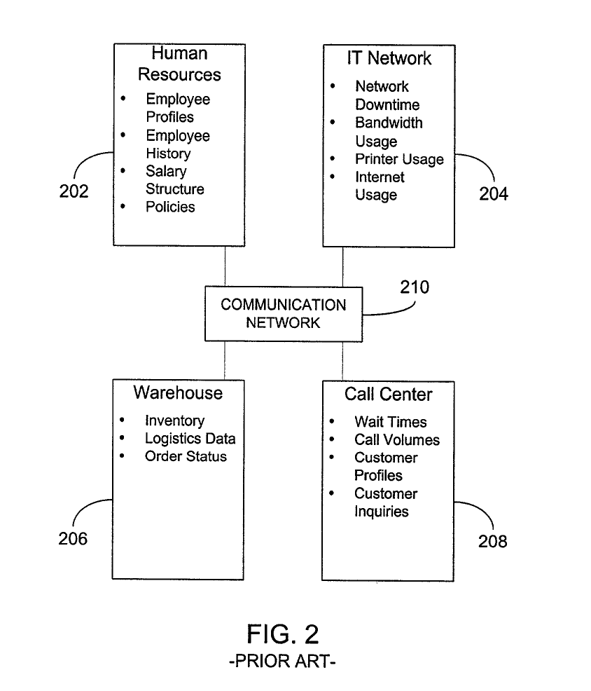

### DETAILED DESCRIPTION OF PREFERRED EMBODIMENTS

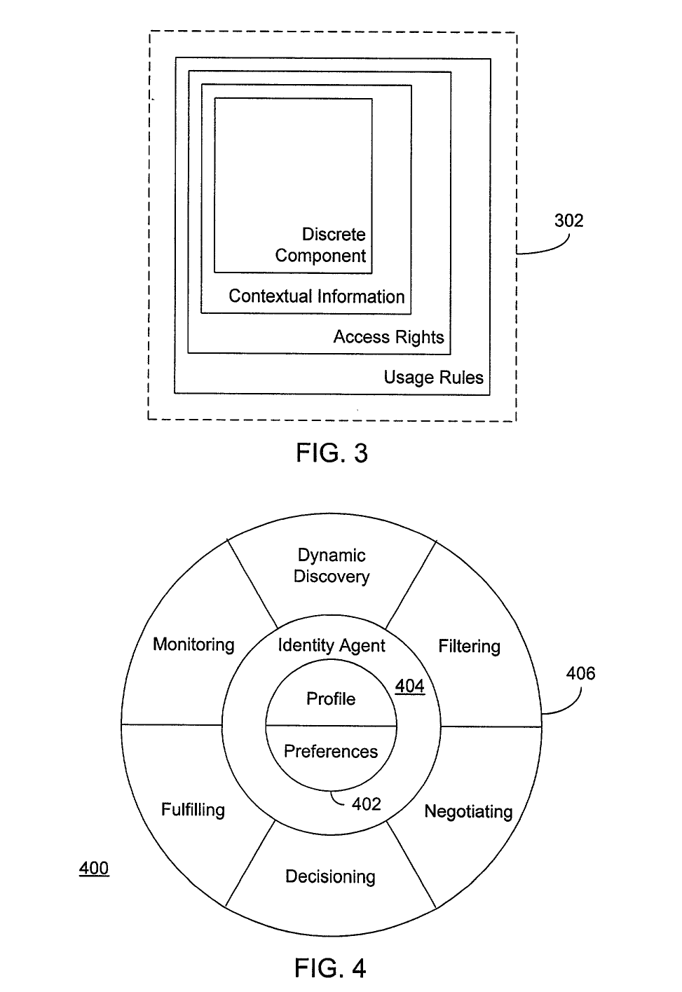

The present invention may be more readily described with reference to FIGS. 3-10. FIG. 3 is a schematic illustration of enhanced data in accordance with the present invention. In particular, FIG. 3 illustrates a hierarchical relationship between the elements that form enhanced content. Although a hierarchical relationship is shown, those having ordinary skill in the art will appreciate that this is for illustrative purposes only and, in practice, enhanced data may be implemented using any of a wide variety of data structures.

At its core, enhanced data is the result of any discrete component (data) that can have value-added attributes or information (i.e., contextual information) added thereto. Each discrete component, in turn, is any piece of data or information from a given content network that can be digitally represented and stored. Examples of such discrete components include, but are not limited to: embedded sensor readings, personal financial information, home inventories, purchase histories, web browsing histories, cellular phone call logs, demographics and physical traits. Each discrete component of data can be made up of files that include text files, Microsoft Office files, video files or files in some other format. In one embodiment of the present invention, the discrete component upon which enhanced data is formed may itself comprise previously-generated enhanced data.

In one embodiment of the invention, contextual information for each discrete component of data is domain specific. Furthermore, multiple sets of contextual information maybe associate with a given domain. For example, a discrete component of data relating to a person's purchase history may be associated with personalized marketing contextual information and separate tax contextual information. The personalized marketing contextual information may include preferences for stores and brands, and the tax contextual information may include an indication of whether the goods or services tax-deductible and how much certain goods have depreciated. That is, the contextual information may comprise attributes about its corresponding discrete component relating to the source, intended delivery channel and audience or characteristics specific to the discrete component. Further still, the contextual information may comprise information regarding feedback based on previous use of the enhanced data. Regardless, the contextual data provides the mechanism whereby the intrinsic value of the discrete component may be more readily recognized and realized by third parties. In a preferred embodiment, the contextual information is embodied in Extensible Markup Language (XML) coding added to each discrete component.

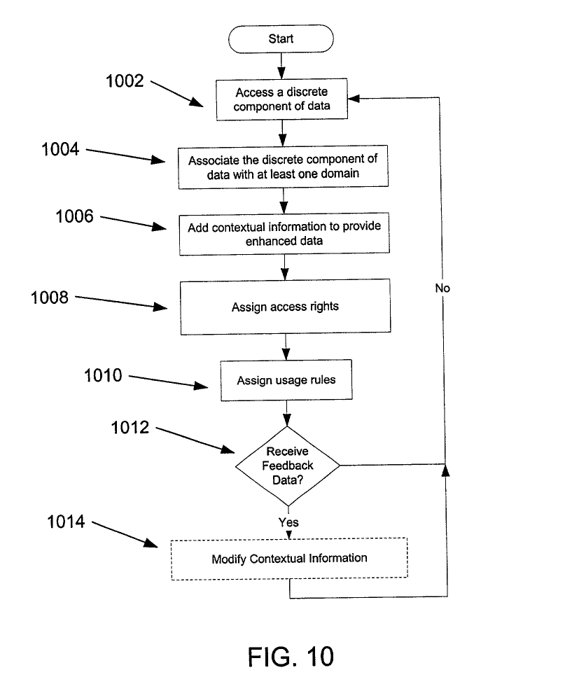

Access rights preferably denote what types or class of users (third parties) may access the transformed discrete components (i.e., discrete components to which contextual information has been added). Usage rules specify how entities authorized to access the enhanced data may use or modify the enhanced data. One usage rule may allow entities to use each component of enhanced data, while another usage rule may only allow entities to use aggregates of several different components of enhanced data. For example, a user may wish to not share their personal income information with an entity but may be willing to have their personal income information aggregated with income information from other users and allow the entity to use the aggregated information. Taken together, the various hierarchical layers illustrated in FIG. 3 make up enhanced data. In a preferred embodiment, enhanced data is stored as a data structure on a computer-readable medium 302, thereby facilitating manipulation of the enhanced data. A more detailed description regarding the creation of enhanced data is provided with regard to FIG. 10 below.

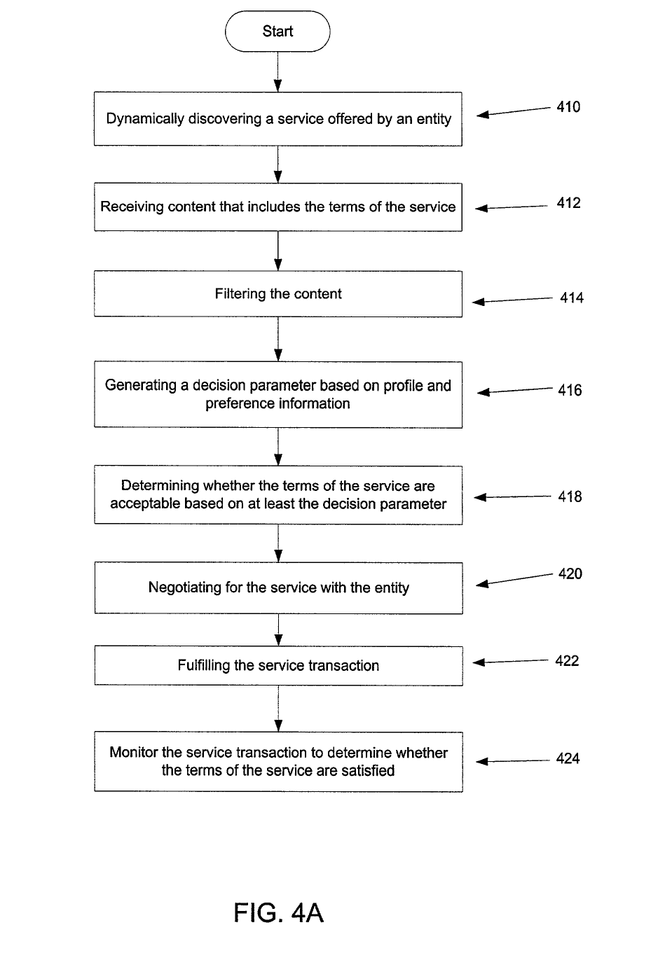

Referring now to FIG. 4, a schematic illustration of a digital identity 400 in accordance with the present invention is illustrated. Digital identity model, or act as a proxy for, an entity using stored identity information 402. Based on the stored identity information 402, a set of services 406 act as the intelligence whereby the digital identity 400 interacts with third parties, preferably modeled by digital identities themselves. An identity agent 404 controls access to and modification of the stored identity information 402. Preferably, the stored identity information 402 resides in a database, and the identity agent 404 is implemented as a one or more software routines executed by a computer or similar platform controlling access to the database. Likewise, the set of services 406 are preferably implemented as one or more software routines executed by the same or similar computer platform.

As shown in FIG. 4, the stored identity information 402 comprises an entity's profile information and preference information. The profile information embodies information regarding current and historical actions and attributes of the corresponding entity. For example, the profile information for an individual may comprise a digital certificate that may be used to substantiate the individual's identity when executing on-line transactions. Similarly, the profile information may comprise suitable financial data, such as bank account and credit card numbers. The profile information may include a variety of more personal information, such a shopping history, medical data, web usage and a variety of other facts about that individual that may be of use to third parties. Similar types of information may be assembled for institutional entities, such a corporation or other organizations. The preferences information may represent the desires and interests of the entity modeled by the digital identity with regard to the profile information.

As shown, the set of services 406 preferably comprises six different services, Dynamic Discovery, Filtering, Negotiating, Decision Making, Fulfilling and Monitoring. For the sake of simplicity, the one or more interfaces between the set of services 406 and third parties (e.g., other digital identities) are not shown in FIG. 4. The operation of digital identity 400, in accordance with one embodiment of the invention, will now be described with reference to FIG. 4A. First, at least one service offered by an entity connected to a computer network is discovered in a Dynamic Discovery step 410. The Dynamic Discovery service manages incoming requests from third parties, which request will typically comprise requests for enhanced data controlled by the digital identity. In step 412, the Dynamic Discovery service receives content that includes the terms of new services from third party providers, and updates the status of existing services of third party providers. When new services are found, or the status of existing services is updated, the profile or preferences information included in the stored identity information 402 may be updated accordingly. The Dynamic Discovery service may be implemented based on the so-called Simple Object Access Protocol (SOAP) and, in particular, upon the SOAP Contract Language (SCL) and UDDI, currently under development. SOAP is a lightweight protocol for exchange of information in a decentralized, distributed environment. It is an XML based protocol that consists of three parts: an envelope that defines a framework for describing what is in a message and how to process it, a set of encoding rules for expressing instances of application-defined data types, and a convention for representing remote procedure calls and responses. SOAP messages are delivered via HTTP.

SCL and the so-called Discovery Of Web Services (DISCO) protocol allow for the discovery of services in a distributed environment, such as the World Wide Web. Of course, the present invention may be used with other platforms, such as Hewlett Packard's eSpeak/village of Services and Sun Microsystems' Jini concept for discovery of services.

A filtering operation is performed in step 414. The Filtering service identifies services and content (preferably, another entity's enhanced data) that will be of interest to its corresponding entity based on the stored identity information 402. In this manner, the digital identity may request content from third parties and only use that content that meets some predefined rule or rules. For example, a corporation may be interested in receiving bids only from parts suppliers that represent their capability to adhere to certain industry-approved manufacturing standards or from companies on a pre-approved business partners list. Examples of techniques for implementing such filtering are known in the art as exemplified, for instance, through the customization rules used by websites such as Yahoo and Excite.

Next, at least one decision parameter based on profile and preference information is generated in step 416. For example, a user's preference information may indicate that the user always pays for services with a credit card. A decision parameter may be generated to indicate that the user desires to purchase the service with a credit card. The terms of the offered service are compared to the generated decision parameter(s) to determine whether or not the terms are acceptable in step 418.

Negotiating is performed in step 420. Based on the preferences information, the Negotiating service confers with other services to establish terms for a desired transaction. Because the preferences information for an entity can include that entity's desires regarding how negotiations with providers of other goods or services should proceed, the Negotiating service can operate automatically and autonomously. In one embodiment of the invention, negotiations are performed by matching of parameters. Negotiations may be based on multiple parameters and, as stated above, some of the parameters may be inferred from the Profile and Preference information that already exists.

The Decision Making service automatically determines whether terms supplied by the Negotiating service are acceptable based on the preferences information. Techniques for making such decisions are currently known in the area of automated trading, for example, where criteria regarding price or market conditions may be established such that transactions occur when one or more conditions are satisfied. As a further example, on-line auction services such as eBay or Amazon allow the use of reserve prices and limit prices to automatically accept/reject bids. Those having ordinary skill in the art will recognize that these technologies may be readily adapted for the purposes of the present invention.

The Fulfilling service enables agreed upon transactions to be executed by the digital identity in step 422, and arranges for delivery of services or content based on the profile or preferences information. For example, where the digital identity has agreed to the purchase of a particular item through its Negotiating and Decision Making services, the Fulfilling service will provide the necessary financial data required to complete the transaction, as well as any digital authentication corresponding to the entity represented by the digital identity. Furthermore, the Fulfilling service will provide the supplier with the necessary information to deliver the item, such as a shipping address and preferred delivery times. In one implementation, the Fulfilling service would be similar to a service that uses PayPal for financial settlement and then initiates an ICE (Internet Content Exchange) message to arrange the delivery terms of syndicated content, like corporate inventory data.

Finally, the Monitoring service observes, but does not participate in, activity by the digital identity in step 424. The Monitoring service can then either recommend changes to the profile or preferences information due to observed trends in the activity, or automatically effectuate such changes. For example, if an individual has recently rented a number of videos in a certain genre, say, action adventures, the profile information can be updated to reflect the individual's like for action adventure movies. Further still, the Monitoring service performs scenario tracking in order to ensure that the proper profile and preference information is used. This is accomplished by determining factors such as an entity's location, the current time, other entities in the proximity, predetermined schedule and current task in which the entity is engaged. For example, an individual may prefer to have all work-related calls forwarded to his or her phone during normal business hours, but that such calls should only be forwarded to his or her home phone after normal business hours if they are marked urgent. By determining the time of day or the individual's location, or the type of data that is being stored in the individual's content network at any given time, the Monitoring service can ensure that the correct preferences are used.

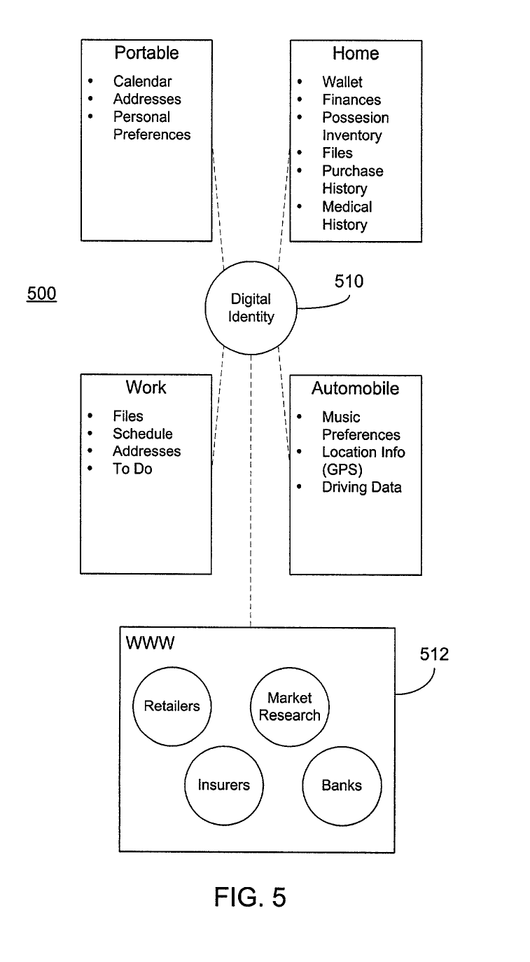

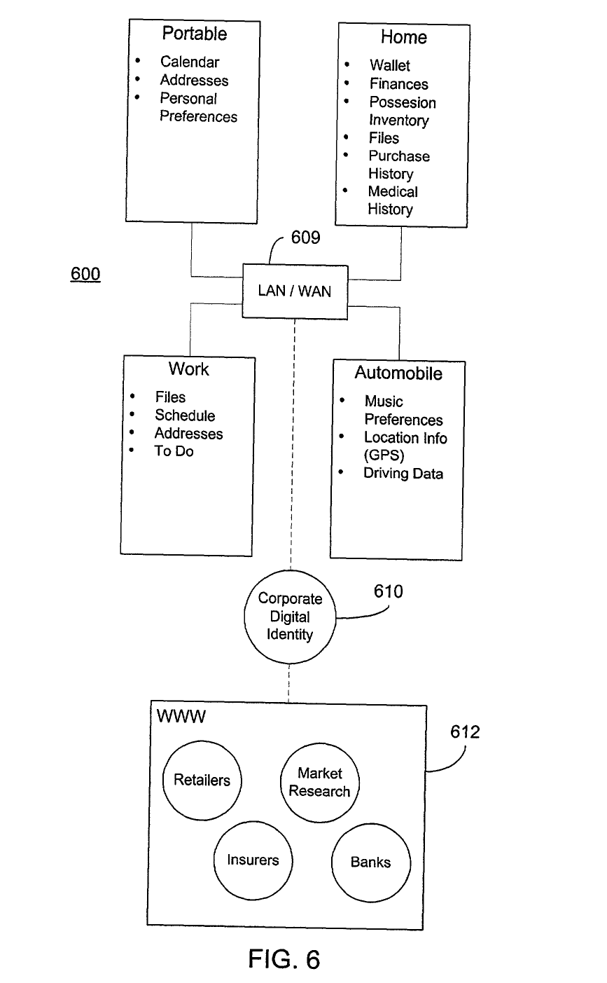

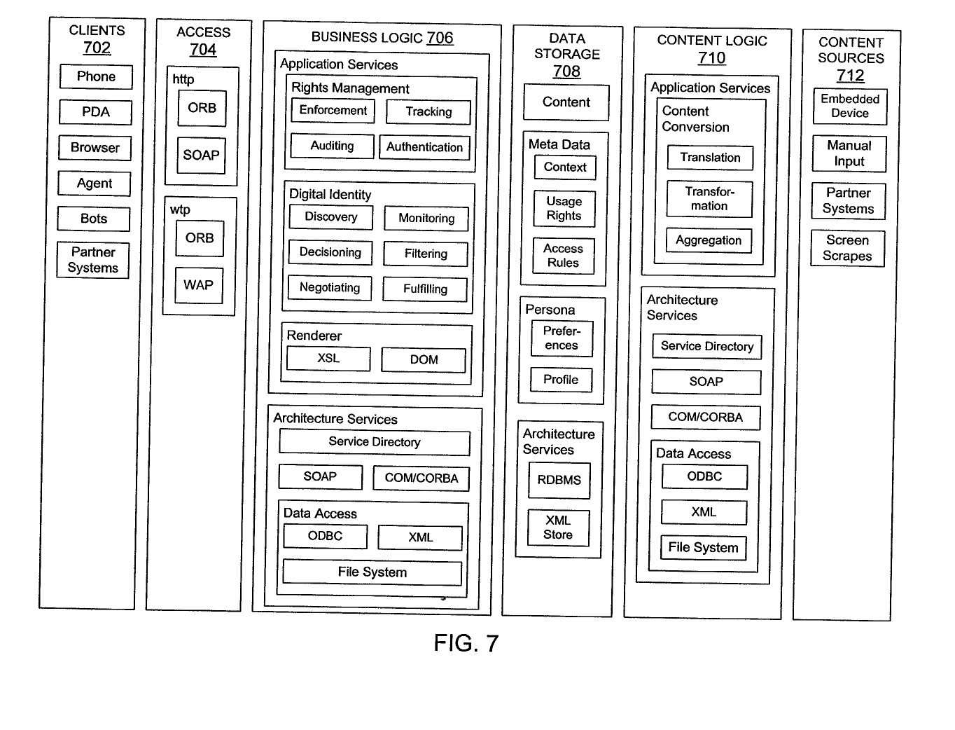

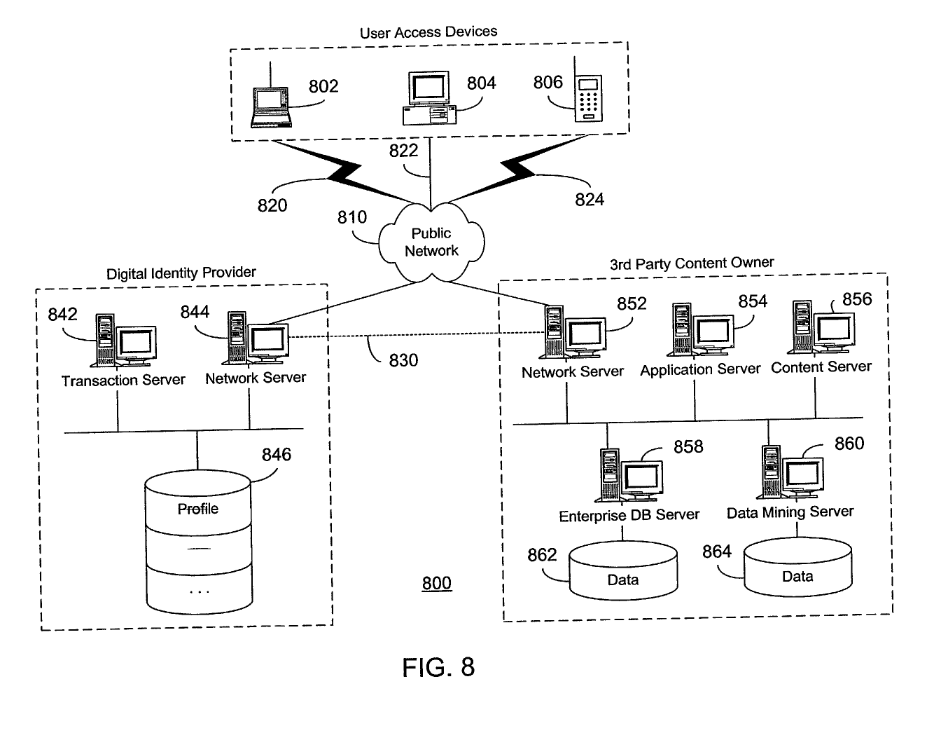

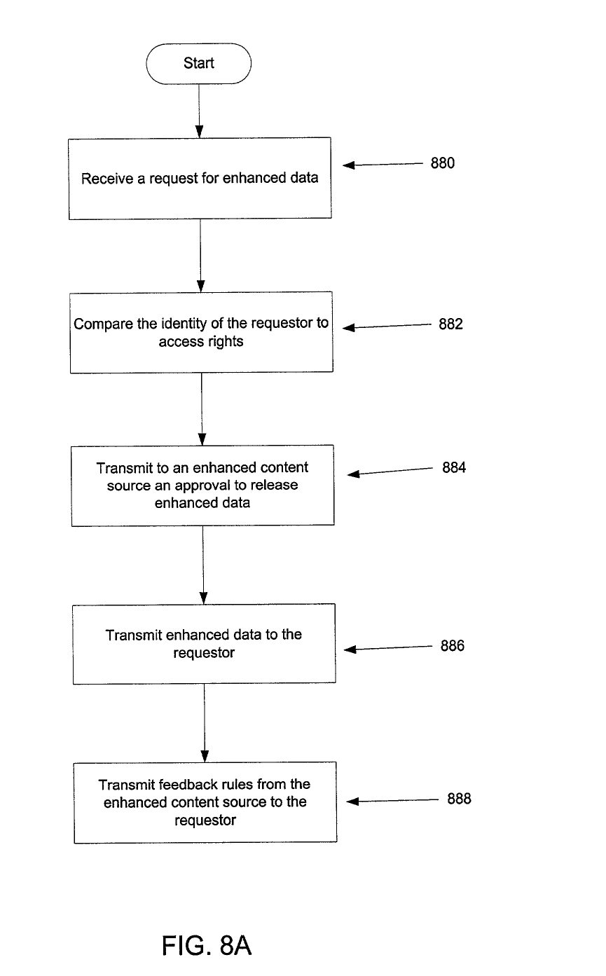

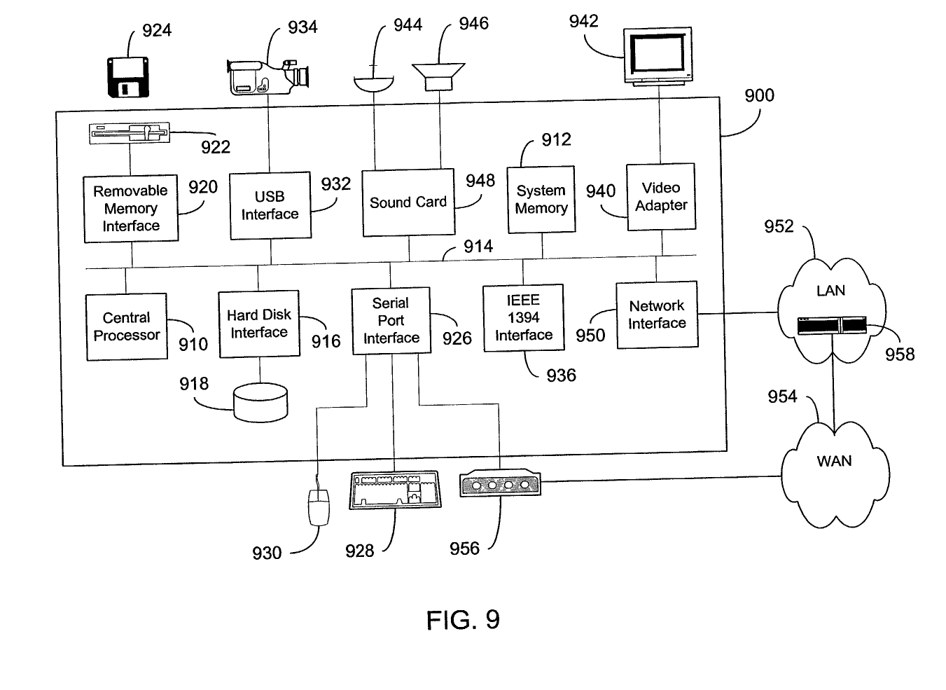

Using enhanced data and digital identities as described relative to FIGS. 3 and 4, the present invention allows the intrinsic value of content networks to be more readily realized. This is illustrated graphically in FIGS. 5 and 6. FIG. 5 illustrates a first embodiment of the present invention in which an individual's content network 500 is logically connected via a digital identity 510 to a plurality of third parties 512, in this case represented by the presence of third parties on the World Wide Web (WWW). The connections between the third parties 512 and the various networks comprising the individual's content network 500 to the digital identity 510 are shown as dotted lines to emphasize the logical, rather than physical, nature of these connections. A preferred physical implementation is further described with reference to FIGS. 8 and 9 below. FIG. 6 illustrates a second embodiment of the present invention in which a corporation's content network 600 includes physical intra-connections in the form of a local area network (LAN) and/or a wide area network (WAN) 609. The corporate digital identity 610 is logically coupled to the LAN/WAN 609 rather than directly to the constituent networks of the corporate content network 600. Such an implementation may be preferable in the case where the content network is particularly large, as might be the case for a corporation of even modest size. As in the case of the individual, the corporate digital identity 610 provides the interface between the corporate content network 600 and any third parties 612. A more detailed view of the logical, as opposed to physical, implementation of the present invention is illustrated in FIG. 7.

FIG. 7 is a schematic illustration of an application architecture that may be used to implement the present invention. The application architecture comprises clients 702, access protocols 704, business logic 706, data storage 708, content logic 710 and content sources 712. Operating together, these elements enable the creation of enhanced data and the realization of values embodied therein through the use of digital identities. Although specific implementations of each of these constituents are shown in FIG. 7, the present invention is not necessarily limited in this manner. In fact, it is anticipated that as new technologies are developed, they may be readily adapted into the framework illustrated in FIG. 7.

The clients 702 represent the various interactive devices or applications that are able to access enhanced data within a content network via the content network's corresponding digital identity. For example, with regard to phones, a Wireless Access Protocol (WAP), Short Message Service (SMS)-enabled cellular phone or email enabled cellular phone can be used to access and receive enhanced data via a digital identity. In one embodiment of the present invention, such a cellular phone may also be used to store the digital identity. In the case of a personal digital assistant (PDA), a WAP-enabled or SMS-enabled device can be used in the same manner as a cellular phone. Once again, such a PDA may also be used to implement the digital identity. Specialized applications may use the digital identity and enhanced data in an entity's content network to negotiate a relationship between content providers to perform activities on behalf of the entity. Finally, partner systems, unlike the above-described specialized applications, rely on pre-defined one-to-one relationships between content providers but are otherwise similar in operation.

The access protocols 704 represent various protocols used to access enhanced data based in part upon the different types of devices (i.e., clients 702) used. Two particular protocols are illustrated in FIG. 7 as being representative of the most likely methods used to access enhanced data. In particular, Hyper Text Transfer Protocol (http) is used by web browsers and agents, whereas Wireless Transaction Protocol (wtp) is used by wireless devices, such as cell phones and PDAs.

In conjunction with http, Object Request Broker (ORB) is the programming that acts as a “broker” between a client request for a service from a distributed object or component such as a digital identity, and the completion of that request. Having ORB support in a network means that a client program can request a service without having to understand where the server is in a distributed network or exactly what the interface to the server program looks like. As a result, components can find out about each other and exchange interface information as they are running. ORB functionality is supported by a technology effort called UDDI (Universal Description Discovery and Integration for the web).

The business logic 706 represents the various business functions carried out in order to access enhanced data. In particular, the business logic 706 may be divided into application services and architecture services. The application services are the higher-level functions used to facilitate the discovery, access and exchange of enhanced data. In turn, the architecture services are the lower-level functions needed to support the higher-level applications.

Within the application services, rights management functionality implements the Access Rights and Usage Rules included with enhanced data as contextual information. The enforcement functionality ensures adherence of usage rules that extrinsically or intrinsically accompany the enhanced data. The tracking functionality manages the viewing, usage, copying, printing, etc. of controlled content. The auditing functionality maintains statistics regarding particular elements of enhanced data, such as the number of times a piece of content has been used, altered, printed, etc. for the purpose of enforcing rights or monetary agreements. Finally, the authentication functionality is used to determine whether someone or something is, in fact, who or what it is declared to be.

The functionality of digital identitys has been previously described with reference to FIG. 4.

The renderer functionality determines the appropriate format (e.g., XML, Hyper Text Markup Language (HTML), Wireless Markup Language (WML), etc.) necessary to display the requested content to a user of the client device. In support of this function, Extensible Stylesheet Language (XSL) stylesheets are used to described how XML-encoded content is to be presented. Similarly, the Document Object Model (DOM) interface allows developers to create applications and scripts to access and update the content, style, and structure of XML-encoded content.

Referring now to the architecture services within the business logic 706, a service directory contains service listings of all services available to users, such as digital identity services as well as directions for accessing and use of the services listed.

At the lowest level of the architecture services, the data access functionality provides the mechanism whereby data is conveyed between destinations. Open Database Connectivity (ODBC) is a standard or open application programming interface for accessing a database by registering a database in an ODBC manager and then referencing the registered alias in an application. ODBC allows outside applications to interface with the existing data in the database. Extensible Markup Language (XML) is a flexible way to create common information formats and share both the format and the data on the World Wide Web. It is preferably used to create, in the context of the present invention, enhanced data by providing metadata (i.e., data describing other data) for existing data or discrete components. Finally, a file system supports the naming an logical placement of files for storage and retrieval.

The data storage 708 represents the physical storage of information including content, meta-data and digital identities. Content comprises one or more discrete components or data as described above. Likewise, the meta-data comprises the contextual information, including usage rules and access rights also described above. In practice, the content and corresponding meta-data are bound together at least in a logical sense, if not physically as well.

Within storage, a digital identity is defined by the preference and profile information about its corresponding entity. As described in greater detail below, digital identities and their corresponding data may be implemented in a centralized fashion, as in the case of a digital identity service provider, or may be implemented locally to their corresponding entities.

In support of the stored information, architecture services such as Relational DataBase Management System (RDBMS) and XML Stores may be used. An RDBMS is a program that lets one to create, update, and administer a relational database. An RDBMS takes Structured Query Language (SQL) statements entered by a user or contained in an application program and creates, updates, or provides access to the database. Some of the best-known RDBMS's include Microsoft SQL Server 2000 and Oracle's Oracle8i. An XML Store is stored data that incorporates the use of XML tags. Such data is stored in a flat file and accessed using XML DOM.

The content logic 710 represents the various functional components used to create enhanced data based on raw data comprising discrete components. The application services included in the content logic 710 include content conversion-related services. The translation service is the mechanism whereby raw data is converted to a common representation format, such as XML-encoded data. The translated data or discrete components may then undergo transformation processing whereby additional contextual information is added to the translated data. Aggregation is the process whereby translated data and its accompanying contextual information is gathered together according to one or more aggregation rules. The output of the aggregation process is enhanced data that has increased value and utility as compared to the original, raw data. The processing associated with content conversion-related services is described in greater detail with regard to FIG. 10. Note that the architecture services associated with the content logic 710 are essentially equivalent to the architecture services associated with the business logic 706.

Finally, the content sources 712 represent the various methods used to acquire raw data that is later converted to enhanced data. For example, a content source may be an embedded device comprising any hardware device that could be a source of raw data or additional content. For example printers (by virtue, for example, of usage data associated therewith), Bluetooth-enabled device or any of a wide variety of other hardware devices may serve as a content source. Content creation can also be done through the manual input of information by an operator or user. For example typing a list of items through a graphical user interface (GUI) can result in an inventory listing. A partner system can be any system that can supply content or raw data to a content aggregator. For example, Sony could be a partner to retailers by providing information about Sony's products. On a reduced scale, for example, a small business could be a partner to its phone service provider by providing information regarding its monthly long distance usage. Finally, screen scrapes are information gathered by agents. That is, an agent can poll information from different web sites. The agent then would go to the different web sites and gather the information for storage it in a local database. Center Stage Agent Builder by Vignette is a suitable tool for creating such agents.

Referring now to FIG. 8, a physical architecture 800 that may be used to implement the present invention is illustrated. In particular, a plurality of user access devices 802-806 are coupled to a public communication network, such as the Internet or World Wide Web, via a plurality of wired or wireless connections 820-824. Note that the connections 820-824 to the public network 810 may be supported by portions of private communication networks (e.g., corporate intranets). By way of example and not limitation, various user access devices are shown in FIG. 8. A portable computing platform 802, such as a laptop computer, is coupled to the public network 810 via a wireless channel in conformance with the so-called Wireless Ethernet standard (IEEE 802.11). A home or office computer 804, such as a desktop computer, is coupled to the public network 810 via a wired connection 822, such as a telephone, cable or fiber optic connection, or any other similar technologies as known in the art. Additionally, a portable communication device 806, such as a cell phone, is coupled to the public network 810 via an appropriate wireless channel 824. Regardless of the particular devices used, the user access devices are the physical interface used to gain access to content networks.

In a presently preferred embodiment, it is anticipated that third party service providers will at least initially implement digital identities in accordance with the present invention. That is, an entity desiring a digital identity will contract with a third party provider. However, as portable computing and communication platforms become increasingly complex and capable, it is also anticipated that entities will be able to maintain digital identities using their own, local platforms. Regardless, the third party digital identity provider illustrated in FIG. 8 encompasses the basic elements necessary to implement digital identities. To this end, a transaction server 842 is provided to implement the business logic corresponding to the digital identities, as well as the underlying architecture services. A network server 844 supports communications between the digital identities implemented by the transaction server 842 and the public network 810. The data storage necessary to implement digital identities (e.g., storage for each entity's profile and preferences information) resides in a database 846 coupled to the servers 842, 844 via a suitable communication bus.

The third party content owners illustrated in FIG. 8 represent the physical networks across which content networks are defined. Thus, such third party content owners provide enhanced data in accordance with the present invention. In a manner similar to third party digital identity providers, the third party content owners will use a network server 852 to support communications with the public network 810. A logical communication path 830 is shown to further illustrate the need for a mechanism that allows the discovery and exchange of enhanced data. In a preferred embodiment, this is achieved using the SOAP-based techniques described above.

An application server 854 implements the business logic necessary to the provision and protection of enhanced data. Similarly, a content server 856 implements the content logic used to create enhanced data. An enterprise database server 858 may be used to control access to data 862 residing in an enterprise's network, such as a large corporate network. A data mining server 860 may be used to analyze vast storehouses of information to come up with usable data sets. For example, a credit card company may need to use Data Mining technologies to develop demographic information on my users. Data mining server 860 may also be used to develop user segmentation for the purposes of advanced personalization like collaborative filtering.

One exemplary method that may be used to transfer information and content between the components that makeup physical architecture 800 is shown in FIG. 8a. First, in step 880 at least one digital identity receives a request for enhanced data. The request may come from another digital identity, an individual, an enterprise or some other source. The digital identity may then compare an identification of the requester to access rights in step 882. Access rights may be stored in database 846. In step 884, the digital identity may then transmit an approval to release enhanced data to the third party content owner. After receiving the approval to release enhanced data, the third party content owner may then transmit the enhanced data to the requester in step 886. Feedback rules may also be transmitted from the third party content owner to the requester in step 888. Of course, the feedback rules may be transmitted at the same time as the enhanced data and may be part of the enhanced data.

Each of the computing devices illustrated in FIG. 8 (e.g., user access devices 802-806, servers 842, 844, 852-860) may be embodied by computing platforms well known in the art. FIG. 9 is a block diagram of a typical prior art workstation, and corresponding communication connections, that may be used to implement the present invention. The present invention may be embodied on a computer system, such as the system 900 shown in FIG. 9. The computer 900 includes a central processor 910, a system memory 912 and a system bus 914 that couples various system components including the system memory 912 to the central processor unit 110. The system bus 914 may be any of several types of bus structures including a memory bus or memory controller, a peripheral bus, and a local bus using any of a variety of bus architectures. The structure of the system memory 912 is well known to those skilled in the art and may include a basic input/output system (BIOS) stored in a read only memory (ROM) and one or more program modules such as operating systems, application programs and program data stored in random access memory (RAM).

The computer 900 may also include a variety of interface units and drives for reading and writing data. In particular, the computer 900 includes a hard disk interface 916 and a removable memory interface 920 respectively coupling a hard disk drive 918 and a removable memory drive 922 to the system bus 914. Examples of removable memory drives include magnetic disk drives and optical disk drives. The drives and their associated computer-readable media, such as a floppy disk 924 provide nonvolatile storage of computer readable instructions, data structures, program modules and other data for computer 900. A single hard disk drive 918 and a single removable memory drive 922 are shown for illustration purposes only and with the understanding that the computer 900 may include several of such drives. Furthermore, the computer 900 may include drives for interfacing with other types of computer readable media.

A user can interact with the computer 900 through a variety of input devices. FIG. 9 shows a serial port interface 926 coupling a keyboard 928 and a pointing device 930 to the system bus 914. The pointing device 930 may be implemented with a mouse, track ball, pen device, or similar device. Of course one or more other input devices (not shown) such as a joystick, game pad, satellite dish, scanner, touch sensitive screen or the like may be connected to the computer 900.

The computer 900 may include additional interfaces for connecting devices to the system bus 914. FIG. 9 shows a universal serial bus (USB) interface 932 coupling, for example, a video or digital camera 934 to the system bus 914. An IEEE 1394 interface 936 may be used to couple additional devices to the computer 900. Furthermore, the IEEE 1394 interface 936 may be configured to operate with particular manufacture interfaces such as FireWire developed by Apple Computer and i.Link developed by Sony. Input devices may also be coupled to the system bus 914 through a parallel port, a game port, a PCI board or any other interface used to couple and input device to a computer.

The computer 900 also includes a video adapter 940 coupling a display device 942 to the system bus 914. The display device 942 may include a cathode ray tube (CRT), liquid crystal display (LCD), field emission display (FED), plasma display or any other device that produces an image that is viewable by the user. Additional output devices, such as a printing device (not shown), may be connected to the computer 900.

Sound can be recorded and reproduced with a microphone 944 and a speaker 946. A sound card 948 may be used to couple the microphone 944 and speaker 946 to the system bus 914. One skilled in the art will appreciate that the device connections shown in FIG. 9 are for illustration purposes only and that several of the peripheral devices could be coupled to the system bus 914 via alternative interfaces. For example, the video camera 934 could be connected to the IEEE 1394 interface 936 and the pointing device 930 could be connected to the USB interface 932.

The computer 900 can operate in a networked environment using logical connections to one or more remote computers or other devices, such as a server, a router, a network personal computer, a peer device or other common network node, a wireless telephone or wireless personal digital assistant. The computer 900 includes a network interface 950 that couples the system bus 914 to a local area network (LAN) 952. Networking environments are commonplace in offices, enterprise-wide computer networks and home computer systems.

A wide area network (WAN) 954, such as the Internet or World Wide Web, can also be accessed by the computer 900. FIG. 9 shows a modem unit 956 connected to the serial port interface 926 and to the WAN 954. The modem unit 956 may be located within or external to the computer 900 and may be any type of conventional modem such as a cable modem or a satellite modem. The LAN 952 may also be used to connect to the WAN 954. FIG. 9 shows a router 958 that may connect the LAN 952 to the WAN 954 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and the computer 900 can be operated in a client-server configuration to permit a user to retrieve web pages from a web-based server. Furthermore, any of various conventional web browsers can be used to display and manipulate data on web pages.

The operation of the computer 900 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

Referring now to FIG. 10, a method for processing data in accordance with the present invention is shown. Preferably, the method illustrated in FIG. 10 is implemented as stored software routines or algorithms executed by a suitable computer platform, for example, the content server 856 of FIG. 8. At step 1002, a discrete component of data is accessed. The data may be accessed by retrieving the data from a memory or receiving the data from another source. Each discrete component is any piece of data or information from the source entity's content network that can be digitally represented and stored. The discrete components may arise for a single data source or multiple data sources within the content network. When more than one discrete component of data is utilized, the discrete components of data may be transformed into the common format.

At step 1004, the discrete component of data is associated with at least one domain. Contextual information is then added and step 1006 to provide in enhanced data. A discrete component of data may be the identification of piece of furniture purchased for a home. A corresponding domain may be a home inventory domain. Contextual information may be the price paid for the furniture, the date of purchase and the color of the item. The addition of the contextual information could result in the encoded data illustrated in Table 2 below:

TABLE 2

. . .
<PRODUCT>

<BRAND>

Jofco

</BRAND>
<TYPE>

Sofa

</TYPE>
<PRICE>

$1,200.79

</PRICE>
<PURCHASE DATE>

4/28/00

</PURCHASE DATE>
<COLOR>

Brown

</COLOR>

</PRODUCT>
. . .

Note that the contextual information added in this example includes information regarding the source of the product (Sony) and characteristics of the product (it is a sofa). Additional contextual information could include information regarding an intended destination for the data, such as a product price for a particular retailer. Access rights and usage rules are assigned in steps 1008 and 1010 respectively. Access rights and usage rules have been described above. Access rights and usage rules associated with the enhanced data could be used to restrict certain manufacturers to information regarding their own product lines. Alternatively, a market research firm could be given more complete access to information regarding all manufacturers products. Those having ordinary skill in the art will recognize that a wide variety of such scenarios are possible in light of the present invention.

At step 1012, it is determined whether any feedback data, responsive to the enhanced data has been received from the destination entity. If so, the feedback data may be optionally used at step 1014 to modify the contextual information associated with the enhanced data. In one implementation of the invention, an ad server may utilize contextual information relating to advertisements. Information indicating which advertisements users viewed be passed back to the ad server. The ad server can then use this additional contextual information (i.e, types of users that like the ad) to help personalize ad delivery even further.

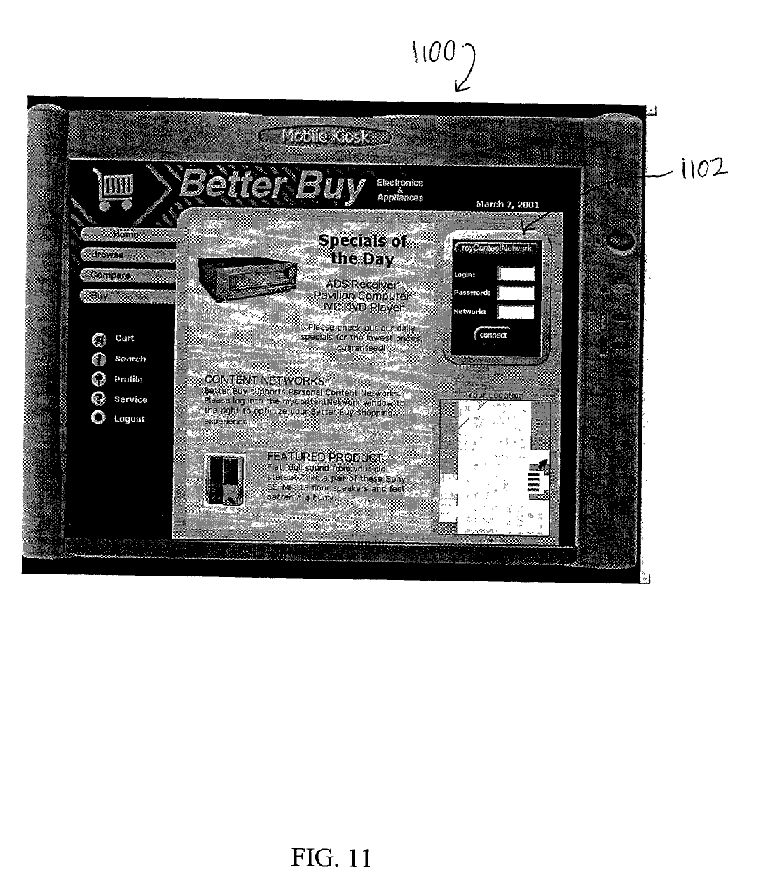

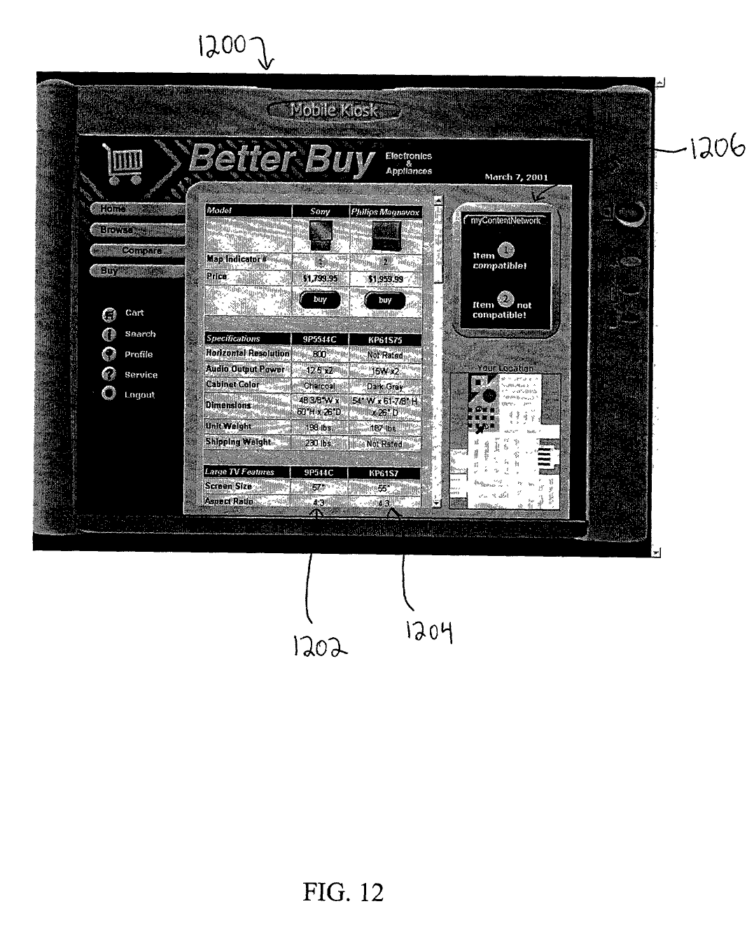

One skilled in the art will appreciate that the present invention can be used with a number of different methods to assist users in purchasing items and making purchasing decisions. FIG. 11 shows a screen 1100 that may be presented on a computer display, kiosk or something device. Screen 1100 includes a box 1102 that allows a user to enter a login name, password and network identification to access the user's enhanced content. FIG. 12 shows a screen 1200 that may be presented to a user who is shopping for a new television after accessing the user's enhanced data. The characteristics of a Sony television are displayed in a column 1202 and the characteristics for a Philips Magnavox television are displayed in a column 1204. The user's enhanced data may be retrieved to determine whether the displayed television sets are compatible with the user's other audiovisual equipment. A display box 1206 informs the user that the Sony television is not compatible with the user's existing audiovisual equipment and that the Philips Magnavox television is compatible with the user's existing audiovisual equipment. The screen shown in FIG. 12 may include a hyperlink or other mechanism (not shown) that allows the user to receive a detailed description of why the components are not compatible.

While the present invention has been described in connection with the illustrated embodiments, it will be appreciated and understood that modifications can be made without departing from the true spirit and scope of the invention.

What is claimed is:

1. A method of associating contextual information with discrete components of data, the method comprising:
accessing at least one discrete component of data from at least one data source;
associating said at least one discrete component of data with at least one domain; and
adding domain specific contextual information to said at least one discrete component of data to provide enhanced data.

2. The method of claim 1, further include the step of:
assigning access rights to the enhanced data.

3. The method of claim 1, further include the step of:
assigning usage rules to the enhanced data.

4. The method of claim 1, further include step of:
encoding the enhanced data with a markup language.

5. The method of claim 4, wherein the markup language comprises the Extensible Markup Language.

6. The method of claim 1, further including the steps of:
associating said at least one discrete component of data with a second domain; and
adding domain specific contextual information to said at least one discrete component of data to provide second enhanced data.

7. The method of claim 1, further including the steps of:
receiving feedback data from a user of the enhanced data; and
modifying the enhanced data to include the feedback data.

8. The method of claim 1, wherein the adding step is performed in real-time.

9. A method of delivering enhanced data through at least one digital identity comprising the steps of:
receiving a request through at least one digital identity for enhanced data from a requestor;
using a digital identity to compare an identification of the requestor to access rights;
transmitting from the digital identity to an enhanced content source an approval to release enhanced data; and
transmitting enhanced data from the enhanced content source to the requestor.

10. The method of claim 9, further including the step of:
comparing at the digital identity an intended use of the enhanced data to usage rules.

11. The method of claim 9, wherein the digital identity is associated with an entity and is operated by a party other than the entity.

12. The method of claim 9, wherein the digital identity is associated with an entity and is operated by the entity.

13. The method of claim 9, wherein the digital identity is associated with an entity and the enhanced content source is operated by a party other than the entity.

14. The method of claim 9, further including the step of:
transmitting feedback rules from the enhanced content source to the requestor.

15. The method of claim 14, wherein the feedback rules comprise an incentive for the requestor to provide feedback to the enhanced content source.

16. A method of obtaining information about services that may be of interest to a user, the method comprising:
discovering at least one service offered by at least one entity connected to at least one computer network;
receiving content from said at least one entity that includes terms of said at least one service;
filtering the content to determine whether the content satisfies at least one predetermined rule
generating at least one decision parameter based on profile and preference information; and
determining whether the terms of said at least one service are acceptable based on at least one decision parameter.

17. The method of claim 16, wherein the discovering step is performed dynamically.

18. The method of claim 16, further including the step of:
negotiating with the at least one entity.

19. The method of claim 16, further including the step of:
providing financial data to the at least one entity to complete a transaction.

20. The method of claim 16, further including the steps of:
monitoring a transaction involving the at least one service; and
modifying the profile and preference information as a result of the monitoring step.

21. A computer-readable medium having stored thereon a data structure comprising:
at least one discrete component of data from at least one data source;
first contextual information that enhances said at least one discrete component of data for a first domain;
second contextual information that enhances said at least one discrete component of data for a second domain; and
wherein the first domain is different from the second domain.

22. The computer readable medium of claim 21, wherein the data structure is encoded with a markup language.

23. The computer readable medium of claim 22, wherein the markup language comprises the Extensible Markup Language.

24. The computer readable medium of claim 21, further including a data field defining usage rules.

25. The computer readable medium of claim 21, further including a data field defining feedback rules.

26. The computer readable medium of claim 21, further including a data field defining access rights.

27. A computer-readable medium having computer-executable instructions for performing the steps comprising:
accessing at least one discrete component of data from at least one data source;
associating said at least one discrete component of data with at least one domain; and adding domain specific contextual information to said at least one discrete component of data to provide enhanced data.

28. A computer-readable medium having computer-executable instructions for performing the steps comprising:
receiving a request through at least one digital identity for enhanced data from a requestor;
using a digital identity to compare an identification of the requestor to access rights;
transmitting from the digital identity to an enhanced content source an approval to release enhanced data; and
transmitting enhanced data from the enhanced content source to the requester.

29. A computer-readable medium having computer-executable instructions for performing the steps comprising:
discovering at least one service offered by at least one entity connected to at least one computer network;
receiving content from said at least one entity that includes terms of said at least one service;
filtering the content to determine whether the content satisfies at least one predetermined rule
generating at least one decision parameter based on profile and preference information; and
determining whether the terms of said at least one service are acceptable based on at least one decision parameter.
